(19) United States
(12) Patent Application Publication
(10) Pub. No.: US 2023/0020026 A1
(43) Pub. Date: Jan. 19, 2023

(54) SYSTEMS AND METHODS FOR INVENTORY MANAGEMENT

(71) Applicant: Walmart Apollo, LLC, Bentonville, AR (US)

(72) Inventors: Souradip Chakraborty, Kolkata (IN); Rajesh Shreedhar Bhat, Uttara Kannada (IN); Somedip Karmakar, Bengaluru (IN)

(73) Assignee: Walmart Apollo, LLC, Bentonville, AR (US)

(21) Appl. No.: 17/864,054

(22) Filed: Jul. 13, 2022

Related U.S. Application Data
(60) Provisional application No. 63/221,415, filed on Jul. 13, 2021.

(51) Int. Cl. G06Q 10/08; G06N 3/08

(52) U.S. Cl. CPC G06Q 10/087; G06N 3/088

(57) ABSTRACT

A systems including one or more processors and one or more non-transitory computer readable media storing computing instructions that, when executed on the one or more processors, perform: receiving a plurality of images from one or more devices, the images corresponding to a store shelf of a store; combining the plurality of images to generate a shelf image corresponding to the store shelf; encoding the shelf image into a first processing format; processing the shelf image in the first processing format with a neural network using pre-trained weights; determining positions in the shelf image that correspond to an out-of-stock detection based on outputs from the neural network; and generating a report for the out-of-stock detection, the report including an indication of coordinates of the out-of-stock detection and an item of the store that corresponds to the coordinates. Other embodiments are described.

### CROSS-REFERENCE TO RELATED APPLICATION

This is a continuation of Provisional Patent Application Ser. No. 63/221,415, filed on Jul. 13, 2021, which is herein incorporated by this reference in its entirety.

### TECHNICAL FIELD

This disclosure relates generally to inventory management, and more particularly to systems and methods for inventory management.

### BACKGROUND

Out of stock scenarios are a part of assortment and replenishment domains. For out of stock scenarios it is ideal to ensure that products are available, and pro-actively determine situations of out-of-stock even before they occur, so that the items can be restocked. However, for large stores with millions of items, it becomes difficult to manually keep track of all the items on shelf.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIG. 3;

FIG. 2 illustrates a representative block diagram of an example of the elements included in the circuit boards inside a chassis of the computer system of FIG. 1;

FIG. 3 illustrates a representative block diagram of a system, according to an embodiment;

FIG. 4 illustrates a flowchart for a method, according to certain embodiments;

FIG. 5 illustrates an exemplary shelf image, according to certain embodiments; and

FIG. 6 illustrates an exemplary system overview, according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processors and one or more non-transitory computer-readable storage devices storing computing instructions. The computing instructions can be configured to run on the one or more processors and perform: receiving a plurality of images from one or more devices, the images corresponding to a store shelf of a store; combining the plurality of images to generate a shelf image corresponding to the store shelf; encoding the shelf image into a first processing format; processing the shelf image in the first processing format with a neural network using pre-trained weights; determining positions in the shelf image that correspond to an out-of-stock detection based on outputs from the neural network; and generating a report for the out-of-stock detection, the report including an indication of coordinates of the out-of-stock detection and an item of the store that corresponds to the coordinates.

Various embodiments include a method. The method can be implemented via execution of computing instructions configured to run at one or more processors and configured to be stored at non-transitory computer-readable media. The method can comprise receiving a plurality of images from one or more devices, the images corresponding to a store shelf of a store; combining the plurality of images to generate a shelf image corresponding to the store shelf; encoding the shelf image into a first processing format; processing the shelf image in the first processing format with a neural network using pre-trained weights; determining positions in the shelf image that correspond to an out-of-stock detection based on outputs from the neural network; and generating a report for the out-of-stock detection, the report including an indication of coordinates of the out-of-stock detection and an item of the store that corresponds to the coordinates.

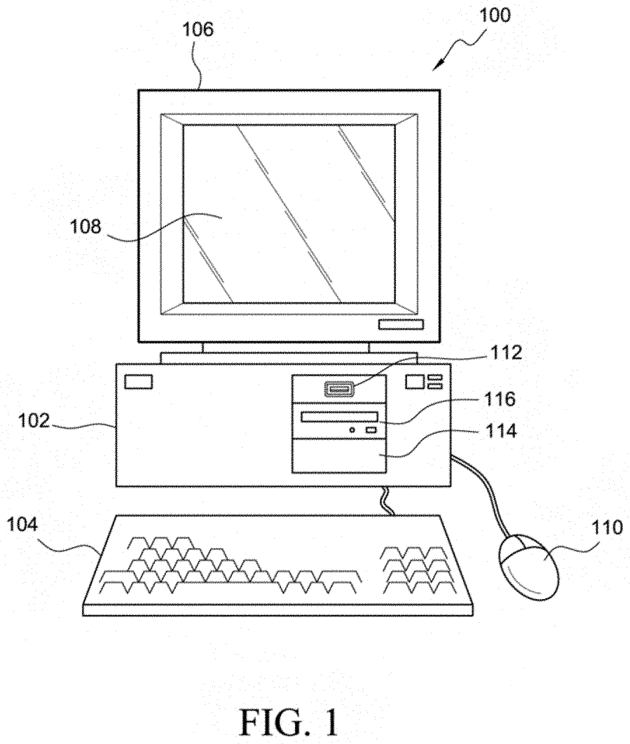

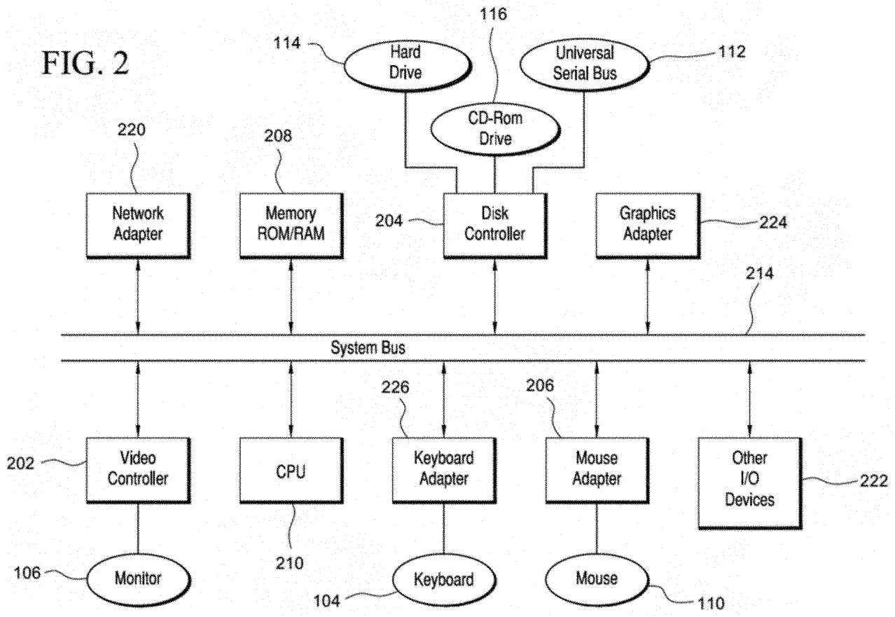

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In many embodiments, all or a portion of memory storage unit 208 can be referred to as memory storage module(s) and/or memory storage device(s). In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

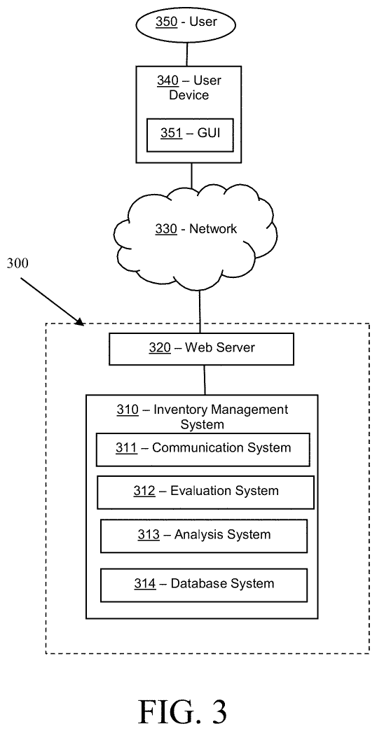

Turning ahead in the drawings, FIG. 3 illustrates a block diagram of a system 300 that can be employed for performing inventory management, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include an inventory management system 310 and/or web server 320, which in some embodiments can implement a computer vision-based solution that can automate the task of determination of potential out-of-stock items and replenish the items from the back room or raise alerts to the replenishment managers to deliver the next batch of products.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Inventory management system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host inventory management system 310 and/or web server 320. Additional details regarding inventory management system 310 and/or web server 320 are described herein.

In some embodiments, web server 320 can be in data communication through a network 330 with one or more user devices, such as a user device 340, which also can be part of system 300 in various embodiments. User device 340 can be part of system 300 or external to system 300. In certain embodiments, user device 340 can be a desktop computers, laptop computers, smart phones, tablet devices, and/or other endpoint devices. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to determine coordinates of items, in addition to other suitable activities. In a number of embodiments, web server 320 can interface with inventory management system 310 when a user (e.g., 350) is determining coordinates of items or out of stock items.

In some embodiments, an internal network that is not open to the public can be used for communications between inventory management system 310 and web server 320 within system 300. Accordingly, in some embodiments, inventory management system 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can comprise the Virtual Retinal Display™ product, or similar product by the University of Washington of Seattle, Wash., United States of America. Meanwhile, in further specific examples, a limb mountable wearable user computer device can comprise the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Wash., United States of America.

In many embodiments, inventory management system 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to inventory management system 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of inventory management system 310 and/or web server 320. In a similar manner, the processors and/or the non-transitory computer-readable media can be local and/or remote to each other.

Meanwhile, in many embodiments, inventory management system 310 and/or web server 320 also can be configured to communicate with one or more databases, such as a database system 314. The one or more databases can include geographical information, shelf image information (e.g., images and metadata), and/or machine learning training data, for example, among other data as described herein. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, inventory management system 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, inventory management system 310 can include a communication system 311, an evaluation system 312, an analysis system 313, and/or database system 314. In many embodiments, the systems of inventory management system 310 can be modules of computing instructions (e.g., software modules) stored at non-transitory computer readable media that operate on one or more processors. In other embodiments, the systems of inventory management system 310 can be implemented in hardware. Inventory management system 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host inventory management system 310 and/or web server 320. Additional details regarding inventory management system 310 and the components thereof are described herein.

In many embodiments, user device 340 can comprise graphical user interface (“GUI”) 351. In the same or different embodiments, GUI 351 can be part of and/or displayed by user device 340, which also can be part of system 300. In some embodiments, GUI 351 can comprise text and/or graphics (image) based user interfaces. In the same or different embodiments, GUI 351 can comprise a heads up display (“HUD”). When GUI 351 comprises a HUD, GUI 351 can be projected onto a medium (e.g., glass, plastic, etc.), displayed in midair as a hologram, or displayed on a display (e.g., monitor 106 (FIG. 1)). In various embodiments, GUI 351 can be color, black and white, and/or greyscale. In many embodiments, GUI 351 can comprise an application running on a computer system, such as computer system 100 (FIG. 1), user device 340. In the same or different embodiments, GUI 351 can comprise a website accessed through network 330. In these or other embodiments, GUI 351 can comprise an administrative (e.g., back end) GUI allowing an administrator to modify and/or change one or more settings in system 300. In the same or different embodiments, GUI 351 can be displayed as or on a virtual reality (VR) and/or augmented reality (AR) system or display. In some embodiments, an interaction with a GUI can comprise a click, a look, a selection, a grab, a view, a purchase, a bid, a swipe, a pinch, a reverse pinch, etc.

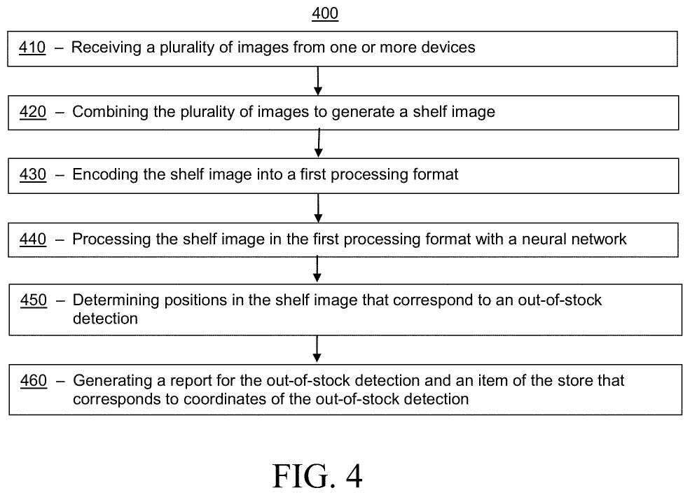

Turning ahead in the drawings, FIG. 4 illustrates a flow chart for a method 400 of providing inventory management, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules. Such non-transitory memory storage modules can be part of a computer system such as inventory management system 310, web server 320, and/or user device 340 (FIG. 3). The processing module(s) can be similar or identical to the processing module(s) described above with respect to computer system 100 (FIG. 1).

In many embodiments, method 400 can comprise an activity 410 of receiving a plurality of images from one or more devices. In some embodiments, the images corresponding to a store shelf of a store. The one or more devices comprise at least one of: a shelf-scanning robot, a drone, or a camera. Each of the one or more devices can operate autonomously, or can be operated by an individual. In some embodiments, the images can be received in real-time, or can be received periodically (e.g., every hour, every 24 hours, every 3 days, etc.). In some embodiment, the images can be accompanied by various inputs. For example, the input comprises shelf images from stores, planogram details like product name, horizontal and vertical facing quantities. Embodiments disclosed herein are directed to identifying and detecting the voids present in the shelf images as partial void or out of stock. As referenced herein, partial void is referred to the configuration when some of the products of a given type are missing from a shelf image, and out of stock indicates that the product is completely missing from the shelf image.

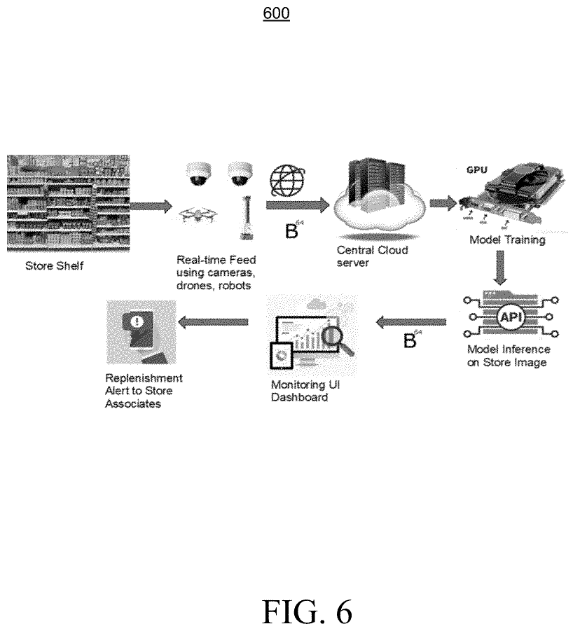

Turning briefly to FIG. 6, a system overview 600 is illustrated. The system overview 600 includes the activities of method 400 from a high level. In the system overview 600, the images are collected from the cameras or drones, then converted to an encoded string format, and passed through an API to the central computing device hosted in central cloud server. The model is deployed as a service through the API, which takes as an input the actual store image in encoded format, then processes the image using pre-trained weights, and outputs the presence or absence of complete or partial out-of-stocks, along with the location coordinates of the void. The output image, with the demarcated voids are encoded and sent back to the store systems as alerts. The model training happens in a batch process at regular interval to keep updating the model parameters with the new data received. For each image frame the steps are ran iteratively and then a comprehensive report on the shelf availability is generated for regular monitoring. If there are instances of partial or completed out-of-stock present in any particular aisle, then an alert can be sent across to the particular store associates or the store manager, on their mobile devices or through email, with details on which products need to be replenished. The system also cross-references with back-room inventory to decide whether to alert the supply chain manager to expedite the next batch of shipment. Further details of system overview 600 are detailed below in connection with the activities of method 400.

Returning to FIG. 4, in many embodiments, method 400 can comprise an activity 420 of combining the plurality of images to generate a shelf image. For example, combining the plurality of images to generate a shelf image corresponding to the store shelf. In some embodiments, combining the plurality of images further comprises combining the plurality of images based on a planogram indicating where items of the store are to be located, the planogram comprising horizontal-facing quantities and vertical-facing quantities. For example, the planogram can include the number of products that are to be positioned on the shelf, how the products are to be positioned, and the positioning of the items. In some embodiments, each of the plurality of images comprise metadata corresponding to a sequential order in which each of the plurality of images was captured. For example, the images can have a sequential number (e.g., 1, 2, 3, etc.) so that a neural network can determine how to combine the images. For example, a first image with a sequential number of 1 can be combined with a second image with a sequential number of 2. In some embodiments, the shelf image is utilized as an input into the neural network.

In many embodiments, method 400 can comprise an activity 430 of encoding the shelf image into a first processing format. In some embodiments, encoding the shelf image into the first processing format further comprises: converting the shelf image to an encoded string format; and/or processing the encoded string format via an application programming interface (API) based on the planogram horizontal facing quantities and vertical facing quantities of a planogram. In some embodiments, the encoded shelf image is utilized as an input into the neural network.

Returning to FIG. 4, in many embodiments, method 400 can comprise an activity 440 of processing the shelf image in the first processing format with the neural network. In particular, processing the shelf image in the first processing format with the neural network using pre-trained weights. In some embodiments, the neural network comprises at least one of: (i) a region-based convolutional neural network (R-CNN), (ii) a Masked Region-Based Convolutional Neural Network, and (iii) Single Shot Detector (SSD). The R-CNN can correctly identify the regions of the main object in the image via proposing bounding boxes having objects and classifying them accurately. The method can apply high-capacity convolutional networks (CNNs) to bottom-up region proposals to localize and segment objects and when there is minimal supervision, supervised pre-training for an auxiliary task, followed by domain-specific fine-tuning, which boosts performance significantly. The Masked Region Based Convolutional Neural Networks can solve instance segmentation problems in a 2-stage framework. In the first stage, the method detects the bounding boxes and in the second stage predicts the object class and generates a mask in pixel level for the object. Masked R-CNN can provide a simple, flexible, and robust framework for object instance segmentation, which can efficiently detect objects in an image while simultaneously generating a high-quality segmentation mask for each instance. SSD can utilize a single shot to detect multiple objects within the image and can be much faster compared with two-shot RPN-based approaches. The method can provide an object detection framework using a single deep neural network by discretizing the output space of bounding boxes into a set of default boxes over different aspect ratios and scales per feature map location. During inference, the model can generate scores for the presence of each object category in each default box and can suggest robust and efficient adjustments to the box and enhance the mapping. Embodiments disclosed herein can utilize the above algorithms to properly identify the most probable region where the out-of-stock can be present. This ensemble framework can provide high accuracy of the model with very fast response time of the model within milliseconds.

In some embodiments, activity 440 can comprise training the neural network using a first set of training data corresponding to a portion of items in the store, and processing the shelf image without retraining the neural network.

Embodiments disclosed herein perform model training and inferencing framework to determine out-of-stock scenarios utilizing the following steps: 1) dataset preparation and augmentation, 2) feature extraction, and 3) model calibration. During dataset preparation and augmentation, one challenge is availability of good quality labeled images with complete and partial out-of-stock present. Embodiments disclosed herein overcome this challenge through the data augmentation technique. The data augmentation technique can include i) dataset creation and formulation in an object detection framework, and ii) dataset augmentation for object detection. The augmentation strategies for object detection tasks are more complex than in simple classification tasks, as tracking of the position of the object can be kept while rotating and translating the image. Embodiments disclosed herein leverage concepts in learning and augmenting high quality data with limited features to mitigate errors.

Regarding feature extraction, the method may extract the features from the data to train the models. Embodiments disclosed herein can utilize Convolutional Neural Networks, which act as a feature extraction layer, and these features are utilized for downstream detecting void regions in a planogram. Convolutional features can be used for classification as well as localization for the task in hand and sometimes features from multiple layers are also used to make the network predict accurate outcomes irrespective of the object size.

In some embodiments, activity 440 can comprise calibrating the neural network using location loss and class loss. The model calibration is done by minimizing on deviation: i) where the object actually is (location loss), ii) what is the object (class loss). These techniques help in increasing confidence of detection of out-of-stock. This is further validated with the information present in the planogram about the number of products planned to be present in the shelf to accurately determine the partial out-of-stock and predict beforehand the estimated time when the product will go out-of-stock based on the rate of purchase.

The method 400 can also include one or more of the following activities:
Reduction of Search Space: Instead of searching the whole shelf image, embodiments disclosed herein can increase the efficiency by reducing the search space to a relevant area.
Color Based Segmentation: Segments image using k-means clustering in Color-(R, G, B) space. Algorithm balances color proximity and space proximity. Higher values give more weight to space proximity, making superpixel shapes more square/cubic.
Price Tag Boundaries: Color based segments will group together products of different quantity/pack size but same colour/shape. Price tags are supposed to be placed at the left bottom corner of the shelf when a new product starts. So this algorithm helps in distinguishing between the products of same brand with different pack sizes/quantities.
Harris Corner Detector is a corner detection operator that is used in computer vision algorithms to extract corners and infer features of an image. This takes the differential of the corner score into account with reference to direction directly, instead of using shifting patches for every 45 degree angles, and is accurate in distinguishing between edges and corners.
Image Matching: An algorithm which matches the given product image to the actual products present in the shelf image.
Template Matching: Loop over the input image at multiple scales (i.e., make the input image progressively smaller and smaller); Apply template matching and keep track of the match with the largest correlation coefficient (along with the x, y-coordinates of the region with the largest correlation coefficient); After looping over all scales, take the region with the largest correlation coefficient and use that as the “matched” region.
Embodiments disclosed herein can utilize augmented template image at different orientations. Metrics used for matching: Cross Correlation: Take every pair of pixels and multiply Sum all products; Cross Coefficient: Similar to Cross Correlation, but normalized with their Covariances.
Pre-trained Image Embeddings: Image embeddings are extracted from pre-trained Deep CNN models trained on vast ImageNet Dataset. The pre-trained embedding encapsulates the relevant information of the image in a vector format. The image vectors are then extracted from the product images and convolved across the shelf image and the cosine similarity is computed between the product image embedding and the convolved part of the shelf image. Higher cosine similarity between the vectors include presence of that particular product in those regions.
Feature Extraction & Matching: Scale Invariant Feature Transform (SIFT) extract keypoints and compute its descriptors. SIFT algorithm uses the difference of Gaussian blurring of an image with two different variances. Keypoints between two images are matched by identifying their nearest neighbours. But in some cases, the second closest-match may be very near to the first. It may happen due to noise or some other reasons. In that case, ratio of closest-distance to second-closest distance is taken. A Flann kdtree based matcher is used to compare the keypoints in the template & original image.

Embodiments disclosed herein can use a deep learning-based void detection algorithm fine-tuned for stores, which can detect out-of-stocks in shelves for different orientations. Void detection is a challenging task for the machines because of factors like depth, contrast, gradients, change in intensity etc. to classify it as a void. In some cases, the void space might not be black or any fixed color, there can be some other products towards the back as well. Moreover, voids might not be very prominent and can be partial empty spaces as well. But, R-CNN based deep learning method efficiently identifies the correct proposal region by a mechanism called single shot detection.

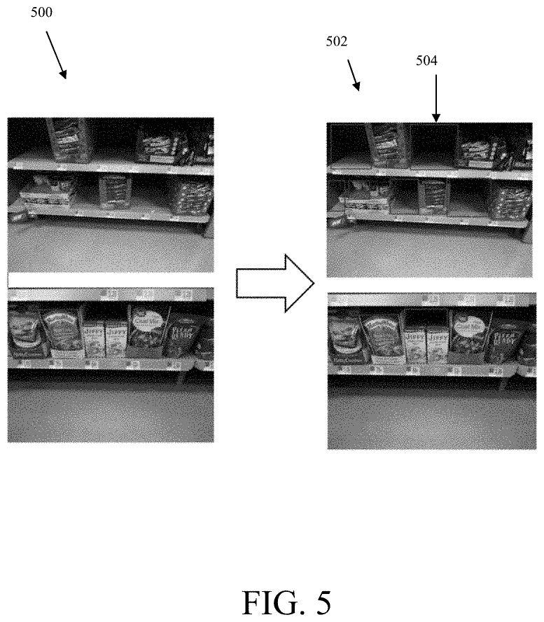

In some embodiments, the outputs of the neural network comprise a probability of a presence or absence of an out-of-stock detection. In some embodiments, the outputs of the neural network can include a probability of a partial out of stock detection. For example, the neural network can output a percentage probability that there is an out of stock detection. The neural network can also prepare an output image that identifies the out of stock or partial void detections. Turning to FIG. 5, a shelf image 500 (e.g., input image) and an output image 502 is illustrated. Output image 502 is produced based on the outputs of the neural network and includes indicators 504 in the image. In the illustrated embodiment, the indicators 504 are boxes that identify where in the image the out of stock or partial void exists, including the coordinates of the out of stock detection.

Returning to FIG. 4, in many embodiments, method 400 can comprise an activity 450 of determining positions in the shelf image that correspond to an out-of-stock detection, which can include determining positions in the shelf image that correspond to an out-of-stock detection based on outputs from the neural network. For example, the output of the neural network can be the output image 502 (FIG. 5), and the output image can include the coordinates of the out of stock detection. Based on the coordinates, the neural network can identify where in the planogram the out of stock detection is and a corresponding product (e.g., item).

In many embodiments, method 400 can comprise an activity 460 of generating a report for the out-of-stock detection and an item of the store that corresponds to coordinates of the out-of-stock detection. In some embodiments, the report can comprise an indication of coordinates of the out-of-stock detection and an item of the store that corresponds to the coordinates. In some embodiments, generating the report for the out-of-stock detection further comprises: generating an alert, and transmitting the alert to an employee. The alert comprises the coordinates of the out-of-stock detection and the item that corresponds to the coordinates.

Returning to FIG. 3, in several embodiments, communication system 311 can at least partially perform activity 410 (FIG. 4).

In several embodiments, evaluation system 312 can at least partially perform activity 420 (FIG. 4) and/or activity 430 (FIG. 4).

In a number of embodiments, analysis system 313 can at least partially perform activity 440 (FIG. 4), activity 450 (FIG. 4) and/or activity 460 (FIG. 4).

In a number of embodiments, web server 320 can at least partially perform method 400 (FIG. 4).

Embodiments disclosed herein provide the following improvements, among others: 1) Semi-supervised Out of Stock Detection Methodology: Very few examples of void images can be fed as an input to the model; Create an intelligent data augmentation framework to enhance the training set intelligently; Ensembled model approach to enhance the semi-supervised performance by capturing the complimentary information. 2) Detection of Partial Void and Out of Stock Detection in less time: High accuracy of the model helps in detecting both the Partial void and Out of Stock; It can be beneficial to understand when there is an out of stock or partial voids so that the business can take immediate actions, and this model is efficient and can inference in less time; It is scalable and can be implemented for any Shelf images and it is able to identify the partial voids and out of stock.

Embodiments disclosed herein can work under different lighting conditions in the store and are robust to partial image presence, and approximate matching. Overall accuracy of the model disclosed herein based on different categories of products is around 90%, which is high, for a semi-supervised model. Embodiments disclosed herein help in providing an automated alert to the store personnel whenever there is an out-of-stock scenario, so that steps can be taken else an out of stock in a shelf is responsible for customer dissatisfaction. It helps the business in merchandizing, replenishment & assortment decisions effectively. This model can provide better compliance of pre-emptive out-of-stock detection, which has significant uplift in incremental sales and improves customer experience.

Although systems and methods for inventory management have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, perform:
receiving a plurality of images from one or more devices, the images corresponding to a store shelf of a store;
combining the plurality of images to generate a shelf image corresponding to the store shelf;
encoding the shelf image into a first processing format;
processing the shelf image in the first processing format with a neural network using pre-trained weights;
determining positions in the shelf image that correspond to an out-of-stock detection based on outputs from the neural network; and
generating a report for the out-of-stock detection, the report including an indication of coordinates of the out-of-stock detection and an item of the store that corresponds to the coordinates.

2. The system of claim 1, wherein the one or more devices comprise at least one of: a shelf-scanning robot, a drone, or a camera.

3. The system of claim 1, wherein combining the plurality of images further comprises combining the plurality of images based on a planogram indicating where items of the store are to be located, the planogram comprising horizontal-facing quantities and vertical-facing quantities.

4. The system of claim 1, wherein each of the plurality of images comprise metadata corresponding to a sequential order in which each of the plurality of images was captured.

5. The system of claim 1, wherein encoding the shelf image into the first processing format further comprises:
converting the shelf image to an encoded string format; and
processing the encoded string format via an application programming interface (API) based on horizontal facing quantities and vertical facing quantities of a planogram.

6. The system of claim 1, wherein the neural network comprises at least one of: (i) a region-based convolutional neural network (R-CNN), (ii) a Masked Region-Based Convolutional Neural Network, and (iii) Single Shot Detector (SSD).

7. The system of claim 6, further comprising calibrating the neural network using location loss and class loss.

8. The system of claim 7, wherein the computing instructions, when executed on the one or more processors, further perform:
training the neural network using a first set of training data corresponding to a portion of items in the store; and
processing the shelf image without retraining the neural network.

9. The system of claim 8, wherein the outputs of the neural network comprise a probability of a presence or absence of an out-of-stock detection.

10. The system of claim 1, wherein generating the report for the out-of-stock detection further comprises:
generating an alert; and
transmitting the alert to an employee, the alert comprising the coordinates of the out-of-stock detection and the item that corresponds to the coordinates.

11. A method implemented via execution of computing instructions configured to run at one or more processors and configured to be stored at non-transitory computer-readable media, the method comprising:
receiving a plurality of images from one or more devices, the images corresponding to a store shelf of a store;
combining the plurality of images to generate a shelf image corresponding to the store shelf;
encoding the shelf image into a first processing format;
processing the shelf image in the first processing format with a neural network using pre-trained weights;
determining positions in the shelf image that correspond to an out-of-stock detection based on outputs from the neural network; and
generating a report for the out-of-stock detection, the report including an indication of coordinates of the out-of-stock detection and an item of the store that corresponds to the coordinates.

12. The method of claim 11, wherein the one or more devices comprise at least one of: a shelf-scanning robot, a drone, or a camera.

13. The method of claim 11, wherein combining the plurality of images further comprises combining the plurality of images based on a planogram indicating where items of the store are to be located, the planogram comprising horizontal-facing quantities and vertical-facing quantities.

14. The method of claim 11, wherein each of the plurality of images comprise metadata corresponding to a sequential order in which each of the plurality of images was captured.

15. The method of claim 11, wherein encoding the shelf image into the first processing format further comprises:
converting the shelf image to an encoded string format; and
processing the encoded string format via an application programming interface (API) based on horizontal facing quantities and vertical facing quantities of a planogram.

16. The method of claim 11, wherein the neural network comprises at least one of: (i) a region-based convolutional neural network (R-CNN), (ii) a Masked Region-Based Convolutional Neural Network, and (iii) Single Shot Detector (SSD).

17. The method of claim 16, further comprising calibrating the neural network using location loss and class loss.

18. The method of claim 17, further comprising:
training the neural network using a first set of training data corresponding to a portion of items in the store; and
processing the shelf image without retraining the neural network.

19. The method of claim 18, wherein the outputs of the neural network comprise a probability of a presence or absence of an out-of-stock detection.

20. The method of claim 11, wherein generating the report for the out-of-stock detection further comprises:
generating an alert; and
transmitting the alert to an employee, the alert comprising the coordinates of the out-of-stock detection and the item that corresponds to the coordinates.
